(19) United States
(12) Patent Application Publication
(10) Pub. No.: US 2018/0079684 A1
(43) Pub. Date: Mar. 22, 2018

(54) CHEMICALLY STRENGTHENED GLASS

(71) Applicant: ASAHI GLASS COMPANY, LIMITED, Chiyoda-ku (JP)

(72) Inventors: Maya HATANO, Tokyo (JP); Koji Nakagawa, Tokyo (JP); Yusuke Kobayashi, Tokyo (JP); Shusaku Akiba, Tokyo (JP)

(73) Assignee: ASAHI GLASS COMPANY, LIMITED, Chiyoda-ku (JP)

(21) Appl. No.: 15/827,326

(22) Filed: Nov. 30, 2017

Related U.S. Application Data
(63) Continuation of application No. PCT/JP2016/067360, filed on Jun. 10, 2016.

(30) Foreign Application Priority Data
Jun. 15, 2015 (JP) 2015-120621

(51) Int. Cl. C03C 21/00; C03C 3/085

(52) U.S. Cl. CPC C03C 21/002; C03C 3/085; B32B 2264/104; C03C 2203/20; C03C 2201/50

(57) ABSTRACT

The present invention relates to a chemically strengthened glass having a first surface and a second surface facing the first surface, and having a compressive stress layer provided on the first surface and the second surface, in which a depth of compressive stress DOL₁ (μm) of the first surface is larger than a depth of compressive stress DOL₂ (μm) of the second surface, and a stress distribution in a sheet thickness direction of the chemically strengthened glass satisfies the following relational expression (1) and the following relational expression (3):

CT₁/CT₂≦0.8 (1)

and

CT₁×L^{1/2}≦30 (MPa·mm^{1/2}) (3).

### TECHNICAL FIELD

The present invention relates to a chemically strengthened glass.

### BACKGROUND ART

Recently, a chemically strengthened glass is used for cover glasses of display devices, for example, mobile devices such as mobile phones or smartphones, televisions, personal computers, or touch panels, or the like (see Patent Document 1, etc.).

Here, as described in Patent Document 1, chemical strengthening treatment for glass is generally carried out by immersing a glass sheet in a melt of a metal salt (for example, potassium nitrate) containing metal ions having a large ionic radius (for example, K ion) to substitute the metal ions having a small ionic radius (for example, Na ion or Li ion) in the glass sheet with the metal ions having a large ionic radius, thereby forming a compressive stress layer on the surface of the glass sheet.

### PRIOR ART DOCUMENT

### Patent Document

PATENT DOCUMENT 1: JP 2013-028506 A

### SUMMARY OF THE INVENTION

### Problems that the Invention is to Solve

A stress profile of a conventional chemically strengthened glass, which has been subjected to chemical strengthening treatment as described in Patent Document 1, is shown in FIG. 1. As shown in FIG. 1, such a chemically strengthened glass has a stress profile that is symmetric in the thickness direction. In this stress profile, the compressive stress is the highest in the first surface and the second surface that are the outermost surfaces of glass. Here, the compressive stress in the outermost surfaces of glass is referred to as a surface compressive stress (CS). The compressive stress gradually lowers toward the direction of the depth of glass from the surface of glass, and at a certain depth (depth of compressive stress, DOL), the compressive stress becomes 0. At a part deeper than the depth of compressive stress (DOL) of glass, a tensile stress is generated so that the integrated value of stress in the thickness direction of glass would be 0. The tensile stress is referred to as an internal tensile stress (CT). In this case, the surface compressive stress (CS, unit: MPa), the depth of compressive stress (DOL, unit: mm) and the internal tensile stress (CT, unit: MPa) are generally expressed according to the following relational expression where the thickness of glass is t (unit: mm). Here, it is presumed that the internal tensile stress CT is a constant value in a tensile stress layer.

CT[MPa]=CS[MPa]×DOL[mm]/(t[mm]−2×DOL[mm])

Here, it is known that, in general, a chemically strengthened glass having a larger CS can more prevent flaw growth by tensile stress. In addition, it is known that a chemically strengthened glass having a larger DOL and a smaller CT is more resistant to flaw and is hardly broken. However, as shown by the above-mentioned relational expression, these requirements are in trade-off relation therebetween, and therefore all of these requirements could not be satisfied at the same time.

A chemically strengthened glass may be used as a cover glass or the like for display devices, and in such a case, one surface alone of the cover glass is exposed outside. In such a cover glass, when various collision objects collide against the surface on the exposed side (the exposed surface) thereof, the glass may be damaged. For example, in the case where collision objects having a relatively large angle at the collision part, such as spherical collision objects or the like collide against the exposed surface of the cover glass, bending is generated in the cover glass, and the surface (rear surface) opposite to the collision surface of the cover glass is given an external force (tensile stress) by bending. Consequently, it is preferable that CS of the rear surface of the cover glass is larger so as to be able to resist to the external force by bending. Also, when collision objects having a relatively small angle at the collision part, such as collision objects having a sharp edge or the like collide against the exposed surface of the cover glass, the exposed surface of the cover glass may be flawed, and in the case where the flaw reaches deeper than the compressive stress layer and where the internal tensile stress on the side near to the exposed surface is large, the cover glass is cracked. Consequently, for making a cover glass resistant to flaw, it is preferable that DOL on the side of the exposed surface of the cover glass is larger and that the internal tensile stress on the side near to the exposed surface is smaller. Namely, in use for cover glasses for display devices and the like, chemical strengthening characteristics desired for chemically strengthened glass differ in each surface thereof.

However, in a cover glass using a chemically strengthened glass that has a stress profile symmetric in the thickness direction thereof, as shown in FIG. 1, the stress distribution on the side near to the exposed surface is equal to the stress distribution on the side near to the rear surface. Consequently, in the case where CS on the rear surface side is enlarged more, CS on the exposed surface side is enlarged in the same manner and, in addition, in the case where DOL on the exposed surface side is enlarged more, DOL on the rear surface side is also enlarged in the same manner, and as a result, the internal tensile stresses on both sides become large values to the same degree. However, as shown above, in the case where the internal tensile stress on the side near to the exposed surface becomes large, glass is readily broken.

Specifically, it is difficult to say that a conventional chemically strengthened glass having a stress profile symmetric in the thickness direction could be always favorable not only for cover glasses but also for other various uses that require chemical strengthening characteristics differing between front and rear sides.

### Means for Solving the Problems

The present inventors have assiduously studied in consideration of the above-mentioned problems in the related art and, as a result, have found that a chemically strengthened glass mentioned below can solve the above-mentioned problems, and have completed the present invention.

Specifically, a chemically strengthened glass of one aspect of the present invention is a chemically strengthened glass having a first surface and a second surface facing the first surface, and having a compressive stress layer provided on the first surface and the second surface, in which:

a depth of compressive stress DOL₁ (μm) of the first surface is larger than a depth of compressive stress DOL₂ (μm) of the second surface, and

a stress distribution in a sheet thickness direction of the chemically strengthened glass satisfies the following relational expression (1) and the following relational expression (3).

CT₁/CT₂≦0.8 (1)

CT₁×L^{1/2}≦30(MPa·mm^{1/2}) (3)

CT₁: A maximum value of a tensile stress (MPa) in a region where a depth from the first surface X is from x₀ to x₁

CT₂: A maximum value of a tensile stress (MPa) in a region where a depth from the first surface X is from x₂ to x_{L}

x₀: A depth (mm) from the first surface to a point at which a compressive stress turns first into a tensile stress in the stress distribution in the sheet thickness direction from the first surface to the second surface

x_{L}: A depth (mm) from the first surface to a point at which a compressive stress turns first into a tensile stress in the stress distribution in the sheet thickness direction from the second surface to the first surface

x₁=0.8x₀+0.2x_{L}(mm)

x₂=0.2x₀+0.8x_{L}(mm)

L=x_{L}−x₀ (mm)

A chemically strengthened glass of another aspect of the present invention is a chemically strengthened glass having a first surface and a second surface facing the first surface, and having a compressive stress layer provided on the first surface and the second surface, in which:

a depth of compressive stress DOL₁ (μm) of the first surface is larger than a depth of compressive stress DOL₂ (μm) of the second surface,

in a stress distribution in a sheet thickness direction of the chemically strengthened glass, a tensile stress function CTₙ(X) (MPa) standardized in a depth X (mm) from the first surface satisfies the following relational expression (2) in a region of X=from x₁ to x₂ (mm), and

the stress distribution in the sheet thickness direction of the chemically strengthened glass satisfies the following relational expression (3).

CTₙ(X)=a(X/L²)+b,a≧3 (2)

CT₁×L^{1/2}≦30(MPa·mm^{1/2}) (3)

CT₁: A maximum value of a tensile stress (MPa) in a region where a depth from the first surface X is from x₀ to x₁

x₀: A depth (mm) from the first surface to a point at which a compressive stress turns first into a tensile stress in the stress distribution in the sheet thickness direction from the first surface to the second surface

x_{L}: A depth (mm) from the first surface to a point at which a compressive stress turns first into a tensile stress in the stress distribution in the sheet thickness direction from the second surface to the first surface

x₁=0.8x₀+0.2x_{L}(mm)

x₂=0.2x₀+0.8x_{L}(mm)

L=x_{L}−x₀ (mm)

### Advantageous Effects of Invention

In the chemically strengthened glass of the present invention, the depth of compressive stress DOL₁ of the first surface is larger than the depth of compressive stress DOL₂ of the second surface, and the chemically strengthened glass has a specific stress distribution in the sheet thickness direction, and has a stress profile asymmetric in the thickness direction. Consequently, the chemically strengthened glass can be favorably used in applications where the chemical strengthening characteristics desired for chemically strengthened glass differ in each surface thereof.

### BRIEF DESCRIPTION OF DRAWINGS

FIG. 1 is a figure showing a stress profile of a conventional chemically strengthened glass.

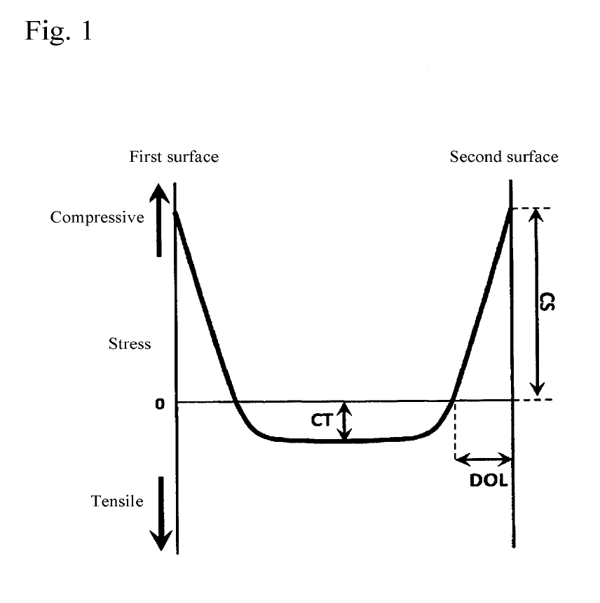

FIG. 2 is a graph showing a stress distribution in the sheet thickness direction of a chemically strengthened glass of one embodiment of the present invention.

FIG. 3 includes figures for explaining a method of calculating the stress distribution in the sheet thickness direction of a chemically strengthened glass of one embodiment of the present invention.

FIG. 4 is a graph showing a stress distribution in the sheet thickness direction of a chemically strengthened glass of one embodiment of the present invention.

FIG. 5 includes figures for illustrating a stress profile in a case where a glass sheet is chemically strengthened through immersion in a melt of a metal salt containing K ions (molten salt) and then the glass sheet is taken out of the molten salt and left at a high temperature.

### MODE FOR CARRYING OUT THE INVENTION

Embodiments of the present invention are described in detail hereinunder.

The chemically strengthened glass of one aspect of the present invention is a chemically strengthened glass having a first surface and a second surface facing the first surface, and having a compressive stress layer provided on the first surface and the second surface, in which the depth of compressive stress DOL₁ (μm) of the first surface is larger than the depth of compressive stress DOL₂ (μm) of the second surface, and the stress distribution in the sheet thickness direction of the chemically strengthened glass satisfies the following relational expression (1) and the following relational expression (3).

CT₁/CT₂≦0.8 (1)

CT₁×L^{1/2}≦30(MPa·mm^{1/2}) (3)

CT₁: A maximum value of tensile stress (MPa) in a region of the depth from the first surface, X=from x₀ to x₁

CT₂: A maximum value of tensile stress (MPa) in a region of the depth from the first surface, X=from x₂ to x_{L}

x₀: A depth from the first surface (mm) to the point at which compressive stress turns first into tensile stress in the stress distribution in the sheet thickness direction from the first surface to the second surface

x_{L}: A depth from the first surface (mm) to the point at which compressive stress turns first into tensile stress in the stress distribution in the sheet thickness direction from the second surface to the first surface

x₁=0.8x₀+0.2x_{L}(mm)

x₂=0.2x₀+0.8x_{L}(mm)

L=x_{L}−x₀ (mm)

The chemically strengthened glass of another aspect of the present invention is a chemically strengthened glass having a first surface and a second surface facing the first surface, and having a compressive stress layer provided on the first surface and the second surface, in which the depth of compressive stress DOL₁ (μm) of the first surface is larger than the depth of compressive stress DOL₂ (μm) of the second surface, in the stress distribution in the sheet thickness direction of the chemically strengthened glass, the tensile stress function CTₙ(X) (MPa) standardized in the depth X (mm) from the first surface satisfies the following relational expression (2) in a region of X=from x₁ to x₂ (mm), and the stress distribution in the sheet thickness direction of the chemically strengthened glass satisfies the following relational expression (3).

CTₙ(X)=a(X/L²)+b,a≧3 (2)

CT₁×L^{1/2}≦30(MPa·mm²) (3)

CT₁: A maximum value of tensile stress (MPa) in a region of the depth from the first surface, X=from x₀ to x₁

x₀: A depth from the first surface (mm) to the point at which compressive stress turns first into tensile stress in the stress distribution in the sheet thickness direction from the first surface to the second surface

x_{L}: A depth from the first surface (mm) to the point at which compressive stress turns first into tensile stress in the stress distribution in the sheet thickness direction from the second surface to the first surface

x₁=0.8x₀+0.2x_{L}(mm)

x₂=0.2x₀+0.8x_{L}(mm)

L=x_{L}−x₀ (mm)

The chemically strengthened glass of another aspect of the present invention is a chemically strengthened glass having a first surface and a second surface facing the first surface, and having a compressive stress layer provided on the first surface and the second surface, in which the depth of compressive stress DOL₁ (μm) of the first surface is larger than the depth of compressive stress DOL₂ (μm) of the second surface, the stress distribution in the sheet thickness direction of the chemically strengthened glass satisfies the above-mentioned relational expression (1) and the above-mentioned relational expression (3), and in the stress distribution in the sheet thickness direction of the chemically strengthened glass, the tensile stress function CTₙ(X) (MPa) standardized in the depth X (mm) from the first surface satisfies the above-mentioned relational expression (2) in a region of X=from x₁ to x₂ (mm).

The chemically strengthened glass of this embodiment has a compressive stress layer according to an ion-exchange method provided on at least the first surface and the second surface. In the ion-exchange method, the surface of glass is ion-exchanged to form a surface layer that has compressive stress remaining therein. Specifically, the alkali metal ions having a small ionic radius (typically, Li ions, Na ions) in the surface of a glass sheet are substituted with alkali ions having a larger ionic radius (typically Na ions or K ions relative to Li ions, and K ions relative to Na ions). As a result, compressive stress remains in the surface of glass and strength of the glass improves.

In the chemically strengthened glass of this embodiment, preferably, a compressive stress layer is formed also on the edge faces thereof in addition to the first surface and the second surface. For example, a rectangular chemically strengthened glass has four edge faces that connect the first surface and the second surface, in which, preferably, a compressive stress layer is formed on all the edge faces. In the case where a compressive stress layer is formed on all surfaces of a chemically strengthened glass in that manner, cracking could be prevented on not only the first surface and the second surface but also the edge faces.

In the chemically strengthened glass of this embodiment, the depth of compressive stress DOL₁ of the first surface is larger than the depth of compressive stress DOL₂ of the second surface. Here, the difference between the depth of compressive stress DOL₁ (μm) of the first surface and the depth of compressive stress DOL₂ (μm) of the second surface (DOL₁-DOL₂) represents a numerical value obtained by subtracting the numerical value of the depth of compressive stress DOL₂ (unit: μm) of the second surface from the numerical value of the depth of compressive stress DOL₁ (unit: μm) of the first surface. In this embodiment, the depth of compressive stress DOL₁ of the first surface is larger than the depth of compressive stress DOL₂ of the second surface, and therefore, DOL₁-DOL₂ is larger than 0 (μm). In the case where DOL₁-DOL₂ is larger than 0 (μm), the tensile stress of glass can be reduced while the fracture resistance thereof after damage to the first surface is enhanced. In the chemically strengthened glass of this embodiment, the depth of compressive stress DOL₁ of the first surface and the depth of compressive stress DOL₂ of the second surface are measured by using a surface stress meter manufactured by Orihara Manufacturing (FSM-6000LE).

Here, in the chemically strengthened glass of this embodiment, the depth of compressive stress DOL₁ (μm) of the first surface and the depth of compressive stress DOL₂ (μm) of the second surface preferably satisfy the following relational expression.

DOL₁≧DOL₂+3(μm)

Specifically, DOL₁-DOL₂ is preferably 3 (μm) or more. In the case where DOL₁-DOL₂ is 3 (μm) or more, each of the first surface and the second surface can more favorably satisfy the chemical strengthening characteristics corresponding to different applications, and breaking of the glass can be more effectively prevented. DOL₁-DOL₂ is more preferably 4 (μm) or more, further more preferably 5 (μm) or more, furthermore preferably 6 (μm) or more, further more preferably 7 (μm) or more, further more preferably 8 (μm) or more, further more preferably 9 (μm) or more, further more preferably 10 (μm) or more, further more preferably 15 (μm) or more, further more preferably 20 (μm) or more, and especially preferably 30 (m) or more.

It is preferred that the depth of compressive stress DOL₁ of the first surface is 15 μm or more, since in the case, excellent fracture resistance can be exhibited even when collision objects having a sharp edge collide against the first surface to make relatively deep flaws therein. The depth of compressive stress DOL₁ of the first surface is more preferably 20 μm or more, further more preferably 25 μm or more, further more preferably 30 μm or more, further more preferably 35 μm or more, further more preferably 40 μm or more, further more preferably 45 μm or more, further more preferably 50 μm or more, further more preferably 60 μm or more, and especially preferably 70 μm or more.

The depth of compressive stress DOL₂ of the second surface is not specifically limited so far as it is smaller than the depth of compressive stress DOL₁ of the first surface, but is, from the viewpoint of realizing high CS₂, preferably 5 μm or more. The depth of compressive stress DOL₂ of the second surface is more preferably 10 μm or more, further more preferably 15 μm or more, further more preferably 20 μm or more, further more preferably 25 μm or more, further more preferably 30 μm or more, further more preferably 35 μm or more, and especially preferably 40 μm or more.

In the chemically strengthened glass of this embodiment, the surface compressive stress CS₁ of the first surface and the surface compressive stress CS₂ of the second surface are not specifically limited, but for reducing the tensile stress of the glass while enhancing the bending strength of the second surface, the surface compressive stress CS₁ of the first surface is preferably smaller than the surface compressive stress CS₂ of the second surface. In the chemically strengthened glass of this embodiment, the surface compressive stress CS₁ of the first surface and the surface compressive stress CS₂ of the second surface are measured by using a surface stress meter manufactured by Orihara Manufacturing (FSM-6000LE).

Here, the difference (CS₁− CS₂) between the surface compressive stress CS₁ (MPa) of the first surface and the surface compressive stress CS₂ (MPa) of the second surface represents a numerical value obtained by subtracting the numerical value of the surface compressive stress CS₂ (unit: MPa) of the second surface from the numerical value of the surface compressive stress CS₁ (unit: MPa) of the first surface. In this embodiment, preferably, the surface compressive stress CS₂ of the second surface is larger than the surface compressive stress CS₁ of the first surface, namely, CS₁-CS₂ is less than 0 (MPa). CS₁-CS₂ is more preferably −10 (MPa) or less, further more preferably −20 (MPa) or less, furthermore preferably −30 (MPa) or less, further more preferably −50 (MPa) or less, further more preferably −70 (MPa) or less, further more preferably −100 (MPa) or less, further more preferably −200 (MPa) or less, further more preferably −300 (MPa) or less, and especially preferably −500 (MPa) or less.

The surface compressive stress CS₁ of the first surface is not specifically limited so far as it is smaller than the surface compressive stress CS₂ of the second surface, but is, from the viewpoint of flaw resistance, preferably 100 MPa or more, more preferably 200 MPa or more, and furthermore preferably 300 MPa or more.

The surface compressive stress CS₂ of the second surface is, from the viewpoint of enhancing the bending resistance of the second surface, preferably 500 MPa or more, more preferably 600 MPa or more, furthermore preferably 700 MPa or more, furthermore preferably 800 MPa or more, further more preferably 900 MPa or more, especially preferably 1000 MPa or more.

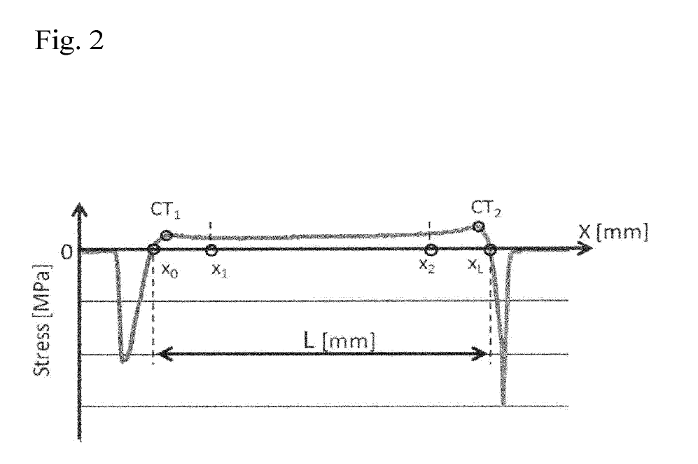

Subsequently, a stress distribution in the chemically strengthened glass of one embodiment of the present invention is described. FIG. 2 is a graph showing a stress distribution in the sheet thickness direction of the chemically strengthened glass of this embodiment. In FIG. 2, the horizontal axis indicates the depth X (mm) from the first surface. The vertical axis indicates stress (MPa). In FIG. 2, stress of a negative value means compressive stress, and stress of a positive value means tensile stress.

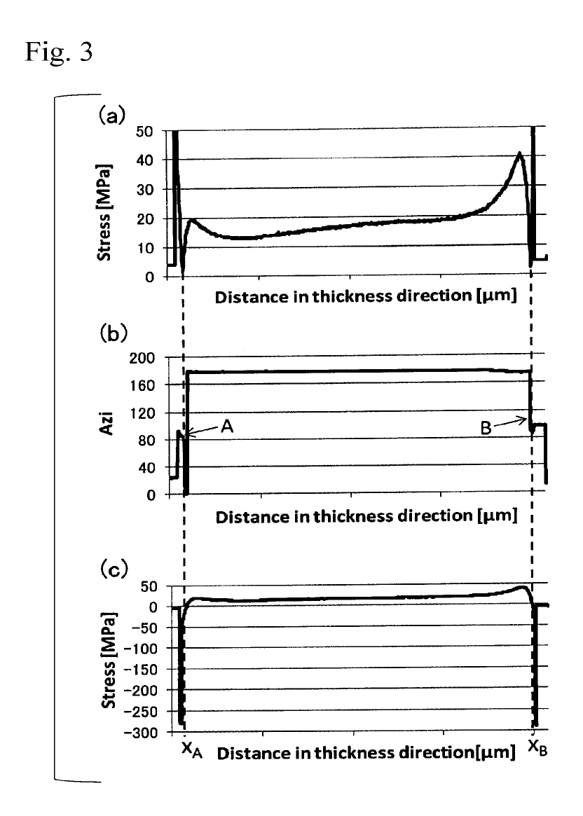

Here, the stress distribution in the sheet thickness direction of the chemically strengthened glass is determined according to the process of the following (1) to (6). The method of determining the stress distribution is described below with reference to FIG. 3. In this embodiment, a mere expression of stress distribution is to indicate the stress distribution determined according to (1) to (6).

(1) First, a measurement sample is cut out of the chemically strengthened glass. For example, from a chemically strengthened glass having a size of the first surface and the second surface of 50 mm×50 mm and a thickness of 0.8 mm, a small piece having a size of the first surface and the second surface of 20 mm×1 mm and a thickness of 0.8 mm is cut out, and then the facing two surfaces having a dimension of 20 mm×0.8 mm are mirror-polished from both sides to prepare a measurement sample having a width of 0.3 mm and a surface roughness Ra of the two surfaces (measurement surfaces) of 5 nm or less. In chemically strengthened glasses that differ in the size and the thickness, a sample is prepared in the same manner without changing the original thickness thereof.

(2) Next, in the measurement sample, by using a birefringence imaging system Abrio (manufactured by Tokyo Instruments), the refractive index distribution and the Azi distribution in the thickness direction of the measurement sample is measured. In measuring the refractive index distribution, the magnification of the objective lens of the systematic biological microscope BX51TF (manufactured by Olympus) is regulated to be 4 to 20 powers so as to enable measurement of the entire measurement surface of the measurement sample. Regarding the measurement condition for the refractive index distribution, the retardation range is 34 nm.

(3) Next, the refractive index constituting each plot of the resultant refractive index distribution is multiplied by a photoelastic constant kc to obtain a stress distribution as in (a) of FIG. 3. The photoelastic constant kc is an intrinsic constant that is uniquely defined depending on material, and in the case of ordinary glass, kc is 25 to 35. The stress distribution obtained herein indicates only the absolute value of stress, not distinguishing tensile stress and compressive stress.

(4) In the Azi distribution as in (b) of FIG. 3, the point in the thickness direction at which the value changes from inside the range of 180n−10≦Azi≦180n+10 (n=0, 1) to outside thereof is referred to as a changing point, and the coordinates of the two changing points A and B are analyzed.

(5) In the distribution in (a) of FIG. 3, where the distribution shows a minimum value at the point in the thickness direction nearest to the each coordinates of the changing points A and B determined in (4), the points in the thickness direction at the minimum value are referred to as x_{A} and x_{B}, respectively. Between x_{A} and x_{B}, the point nearer to the first surface corresponds to x₀, and the point remoter from the first surface corresponds to x_{L}. Specifically, |x_{A}−x_{B}|=x_{L}−x₀=L.

(6) Finally, through plus-minus inversion in the distribution outside the range of from x_{A} to x_{B}, a stress distribution can be obtained in which tensile stress is positive and compressive stress is negative as in (c) of FIG. 3.

The stress distribution in the sheet thickness direction of the chemically strengthened glass of this embodiment satisfies following relational expression (1) and the following relational expression (3).

CT₁/CT₂≦0.8 (1)

CT₁×L^{1/2}≦30(MPa·mm^{1/2}) (3)

CT₁: A maximum value of tensile stress (MPa) in a region of the depth from the first surface, X=from x₀ to x₁

CT₂: A maximum value of tensile stress (MPa) in a region of the depth from the first surface, X=from x₂ to x_{L}

x₀: A depth from the first surface (mm) to the point at which compressive stress turns first into tensile stress in the stress distribution in the sheet thickness direction from the first surface to the second surface

x_{L}: A depth from the first surface (mm) to the point at which compressive stress turns first into tensile stress in the stress distribution in the sheet thickness direction from the second surface to the first surface

x₁=0.8x₀+0.2x_{L}(mm)

x₂=0.2x₀+0.8x_{L}(mm)

L=x_{L}−x₀ (mm)

In FIG. 2, L (mm) indicates the distance between x₀ and x_{L}, and means the thickness of a tensile stress layer. x₁ can be expressed also as x₀+0.2 L (mm), and x₂ can be expressed also as x_{L}−0.2 L (mm).

In the above-mentioned relational expression (1), in the case where CT₁/CT₂ is 0.8 or less, excellent fracture resistance can be exhibited when collision objects having a relatively small collision angle, for example, collision objects having a sharp edge collide against the first surface thereof. CT₁/CT₂ is more preferably 0.75 or less, further more preferably 0.7 or less, further more preferably 0.65 or less, and especially preferably 0.6 or less.

In the relational expression (1), in the case where CT₁ is a small value, it is excellent in effect of suppression or prevention of explosive glass fracture caused by tensile stress. Here, the present inventors have empirically found that the degree of CT₁ depends on the thickness L of the tensile stress layer and is in inverse proportion to the square root of the thickness L of the tensile stress layer. Consequently, in the case where the above-mentioned relational expression (3) is satisfied, that is, CT₁×L^{1/2} is 30 (MPa·mm^{1/2}) or less, it is excellent in effect of suppression or prevention of explosive glass fracture caused by tensile stress. CT₁×L^{1/2} is preferably 25 (MPa·mm^{1/2}) or less, more preferably 23 (MPa·mm^{1/2}) or less, further more preferably 20 (MPa·mm^{1/2}) or less, and especially preferably 18 (MPa·mm^{1/2}) or less.

In this embodiment, CT₂×L^{1/2} is not specifically limited so far as it satisfies the above-mentioned relational expression (1), but from the viewpoint of increasing CS₂ to thereby improve bending resistance, CT₂×L^{1/2} is preferably 5 (MPa·mm^{1/2}) or more, more preferably 10 (MPa·mm^{1/2}) or more, further more preferably 15 (MPa·mm^{1/2}) or more, and especially preferably 20 (MPa·mm^{1/2}) or more. From the viewpoint of reducing the total tensile stress of glass, CT₂×L^{1/2} is preferably 50 (MPa·mm^{1/2}) or less, more preferably 45 (MPa·mm^{1/2}) or less, and further more preferably 40 (MPa·mm^{1/2}) or less.

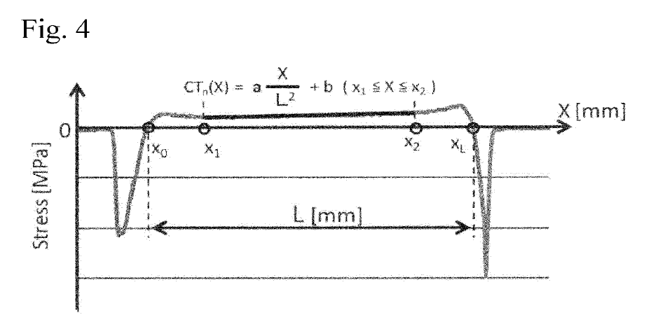

The stress distribution of the chemically strengthened glass of another embodiment of the present invention is described. FIG. 4 is a graph showing the stress distribution in the sheet thickness direction of the chemically strengthened glass of this embodiment. This stress distribution can be determined according to the process of the above-mentioned (1) to (6). In FIG. 4, the horizontal axis indicates the depth X (mm) from the first surface. The vertical axis indicates stress (MPa). In FIG. 4, stress of a negative value indicates compressive stress, and stress of a positive value indicates tensile stress.

In the stress distribution in the sheet thickness direction of the chemically strengthened glass of this embodiment, the tensile stress function CTₙ(X) (MPa) standardized in the depth X (mm) from the first surface satisfies the following relational expression (2) in a region of X=from x₁ to x₂ (mm), and the stress distribution in the sheet thickness direction satisfies the following relational expression (3).

CTₙ(X)=a(X/L²)+b,a≧3 (2)

CT₁×L^{1/2}≦30(MPa·mm^{1/2}) (3)

CT₁: A maximum value of tensile stress (MPa) in a region of the depth from the first surface, X=from x₀ to x₁

x₀: A depth from the first surface (mm) to the point at which compressive stress turns first into tensile stress in the stress distribution in the sheet thickness direction from the first surface to the second surface

x_{L}: A depth from the first surface (mm) to the point at which compressive stress turns first into tensile stress in the stress distribution in the sheet thickness direction from the second surface to the first surface

x₁=0.8x₀+0.2x_{L}(mm)

x₂=0.2x₀+0.8x_{L}(mm)

L=x_{L}−x₀ (mm)

In FIG. 4, L (mm) indicates the distance between x₀ and x_{L}, and means the thickness of the tensile stress layer. x₁ can be expressed also as x₀+0.2 L (mm), and x₂ can be expressed also as x_{L}−0.2 L (mm).

In this embodiment, the wording that “in the stress distribution in the sheet thickness direction, the tensile stress function CTₙ(X) (MPa) standardized in the depth X (mm) from the first surface satisfies the relational expression (2) in a region of X=from x₁ to x₂ (mm)” means that CTₙ(X)=a(X/L²)+b that is the function of X/L² satisfies a ≧3, the function being obtained by linearly approximating CT(X) (MPa) according to a method of least squares in a region where the depth X (mm) from the first surface is from x₁ to x₂ (mm) (x₁≦X≦x₂), followed by standardizing it by using the thickness of the tensile stress layer, L=x_{L}−x₀ (mm).

CT(X) is standardized in the tensile stress distribution in the case where the thickness L of the tensile stress layer of glass is 1.0 (mm). First, the absolute value of CT(X) in which X is from x₁ to x₂ (mm) is in inverse proportion to the thickness L of the tensile stress layer, and CT(X) is therefore multiplied by L⁻¹ to regulate the absolute value. The inclination of the tensile stress distribution in the sheet thickness direction is also in inverse proportion to the thickness L of the tensile stress layer, and the inclination is also multiplied by L⁻¹ for standardization. As a result, in standardization to the tensile stress distribution in the case where the thickness L of the tensile stress layer of glass is 1.0 (mm), the standardized tensile stress function CTₙ(X) is in the form of a linear function of X/L².

In the above-mentioned relational expression (2), in the case where a is 3 or more, excellent fracture resistance can be exhibited when collision objects having a relatively small collision angle, for example, collision objects having a sharp edge collide against the first surface thereof. a is more preferably 4 or more, further more preferably 5 or more, further more preferably 6 or more, and especially preferably 6.5 or more. The upper limit of a is preferably 20 or less, more preferably 15 or less, further more preferably 10 or less. In the relational expression (2), b is an arbitrary real number to be obtained through linear approximation according to a method of least squares, and is not specifically limited.

In this embodiment, in the case where CT₁ is a small value, it is excellent in effect of suppression or prevention of explosive glass fracture caused by tensile stress. Here, the degree of CT₁ is in inverse proportion to the root square of the thickness L of the tensile stress layer. Consequently, in the case where the above-mentioned relational expression (3) is satisfied, that is, CT₁×L^{1/2} is 30 (MPa·mm^{1/2}) or less, it is excellent in effect of suppression or prevention of explosive glass fracture caused by tensile stress. CT₁×L^{1/2} is preferably 23 (MPa·mm^{1/2}) or less, more preferably 20 (MPa·mm^{1/2}) or less, further more preferably 18 (MPa·mm^{1/2}) or less.

Next, a method for producing the chemically strengthened glass of this embodiment is described.

The glass substrate for use in this embodiment is not specifically limited so far as it is ion-exchangeable one, and may be adequately selected from, for example, soda-lime glass, aluminosilicate glass, borosilicate glass, and aluminoborosilicate glass, and may be used.

One example of a composition of the glass substrate for use in this embodiment includes glass that contains, as a composition thereof expressed by mol %, from 50 to 80% of SiO₂, from 0.1 to 30% of Al₂O₃, from 3 to 30% of Li₂O+Na₂O+K₂O, from 0 to 25% of MgO, from 0 to 25% of CaO, and from 0 to 5% of ZrO₂, though not specifically limited thereto. More specifically, glass compositions mentioned below are included here. For example, “containing from 0 to 25% of MgO” means that, though MgO is not indispensable, it may be contained at up to 25%.

(i) Glass having a composition containing, in terms of mol %, from 63 to 73% of SiO₂, from 0.1 to 5.2% of Al₂O₃, from 10 to 16% of Na₂O, from 0 to 1.5% of K₂O, from 5 to 13% of MgO, and from 4 to 10% of CaO.
(ii) Glass having a composition containing, in terms of mol %, from 50 to 74% of SiO₂, from 1 to 10% of Al₂O₃, from 6 to 14% of Na₂O, from 3 to 11% of K₂O, from 2 to 15% of MgO, from 0 to 6% of CaO, and from 0 to 5% of ZrO₂, in which the total content of SiO₂ and Al₂O₃ is 75% or less, the total content of Na₂O and K₂O is 12 to 25%, and the total content of MgO and CaO is 7 to 15%.
(iii) Glass having a composition containing, in terms of mol %, from 68 to 80% of SiO₂, from 4 to 10% of Al₂O₃, from 5 to 15% of Na₂O, from 0 to 1% of K₂O, from 4 to 15% of MgO, and from 0 to 1% of ZrO₂.
(iv) Glass having a composition containing, in terms of mol %, from 67 to 75% of SiO₂, from 0 to 4% of Al₂O₃, from 7 to 15% of Na₂O, from 1 to 9% of K₂O, from 6 to 14% of MgO, and from 0 to 1.5% of ZrO₂, in which the total content of SiO₂ and Al₂O₃ is from 71 to 75%, the total content of Na₂O and K₂O is from 12 to 20%, and the content of CaO, if any, is less than 1%.
(v) Glass having a composition containing, in terms of mol %, from 60 to 72% of SiO₂, from 8 to 16% of Al₂O₃, from 8 to 18% of Na₂O, from 0 to 3% of K₂O, from 0 to 10% of MgO, and from 0 to 5% of ZrO₂, in which the content of CaO, if any, is less than 1%.
(vi) Glass having a composition containing, in terms of mass %, from 65 to 75% of SiO₂, from 0.1 to 5% of Al₂O₃, from 1 to 6% of MgO, and from 1 to 15% of CaO, in which Na₂O+K₂O is from 10 to 18%.
(vii) Glass having a composition containing, in terms of mass %, from 65 to 72% of SiO₂, from 3.4 to 8.6% of Al₂O₃, from 3.3 to 6% of MgO, from 6.5 to 9% of CaO, from 13 to 16% of Na₂O, from 0 to 1% of K₂O, from 0 to 0.2% of TiO₂, from 0.01 to 0.15% of Fe₂O₃, and from 0.02 to 0.4% of SO₃, in which (Na₂O+K₂O)/Al₂O₃ is from 1.8 to 5.0.
(viii) Glass having a composition containing, in terms of mass %, from 60 to 72% of SiO₂, from 1 to 10% of Al₂O₃, from 5 to 12% of MgO, from 0.1 to 5% of CaO, from 13 to 19% of Na₂O, and from 0 to 5% of K₂O, in which RO/(RO+R₂O) is 0.20 or more and 0.42 or less (in the formula, RO represents an alkaline earth metal oxide, and R₂O represents an alkali metal oxide).

The glass substrate for use in the chemically strengthened glass of this embodiment has two main surfaces of a first surface and a second surface, and has edge faces adjacent to these to form the sheet thickness of the substrate, in which the two main surfaces may form flat faces parallel to each other. However, the morphology of the glass substrate is not limited thereto, and for example, the two main surfaces may not be parallel to each other, and all or a part of one or both of the two main surfaces may be a curved face. More specifically, the glass substrate may be a tabular glass substrate with no warp, or may be a curved glass substrate having a curved surface.

The sheet thickness of the glass substrate for use in this embodiment is not specifically limited.

In the method for producing the chemically strengthened glass of this embodiment, the other steps than the chemical strengthening treatment step are not specifically defined and may be adequately selected, and typically, any conventional known steps are applicable herein.

For example, raw materials of the components of glass are prepared and heated to melt in a glass melting furnace. Subsequently, the glass is homogenized by bubbling, stirring, addition of a clarifying agent, or the like, and then formed into a glass sheet having a predetermined thickness according to a conventional known method, and thereafter gradually cooled.

The glass forming method includes, for example, a float method, a press method, a fusion method, and a down-draw method. In particular, a float method suitable for mass production is preferred. Other continuous forming methods than a float method, that is, a fusion method and a down-draw method are also preferred.

Subsequently, the formed glass is cut into a desired size, and is optionally ground and polished to produce a glass substrate. Then, the glass substrate formed is subjected to chemical strengthening treatment mentioned below, and then washed and dried to produce the chemically strengthened glass of this embodiment.

The chemical strengthening treatment in the method for producing the chemically strengthened glass of this embodiment is described below.

In general, the ion interdiffusion phenomenon in chemical strengthening treatment follows the diffusion equation shown below. In the following, a case where the alkali ion having a larger ionic radius subjected to ion exchange is a K ion is described.

$${C}_{x} = {C}_{0} + ( {C}_{eq} - {C}_{0} ) \{ erfc \frac{x}{2 \sqrt{Dt}} - exp ( \frac{H}{D} x + \frac{{H}^{2}}{D} t ) erfc ( \frac{x}{2 \sqrt{Dt}} + \frac{H}{D} \sqrt{Dt} ) \} \qquad [ Math . 1 ]$$

(t: time (s), x: position from the glass surface in the thickness direction (unit: μm), Cₓ: K ion concentration (mol %) at the position x at the time t, Co: initial K ion concentration (mol %), C_{eq}: K ion concentration (mol %) in an equilibrium state, D: a diffusion coefficient (m²/s), and H: mass transfer coefficient (m/s))

Here, the diffusion coefficient D is an index of the speed of diffusion of K ions inside glass. The mass transfer coefficient H is an index of the speed of transfer of K ions into glass from the surface layer of glass. Both the diffusion coefficient D and the mass transfer coefficient H depend on temperature.

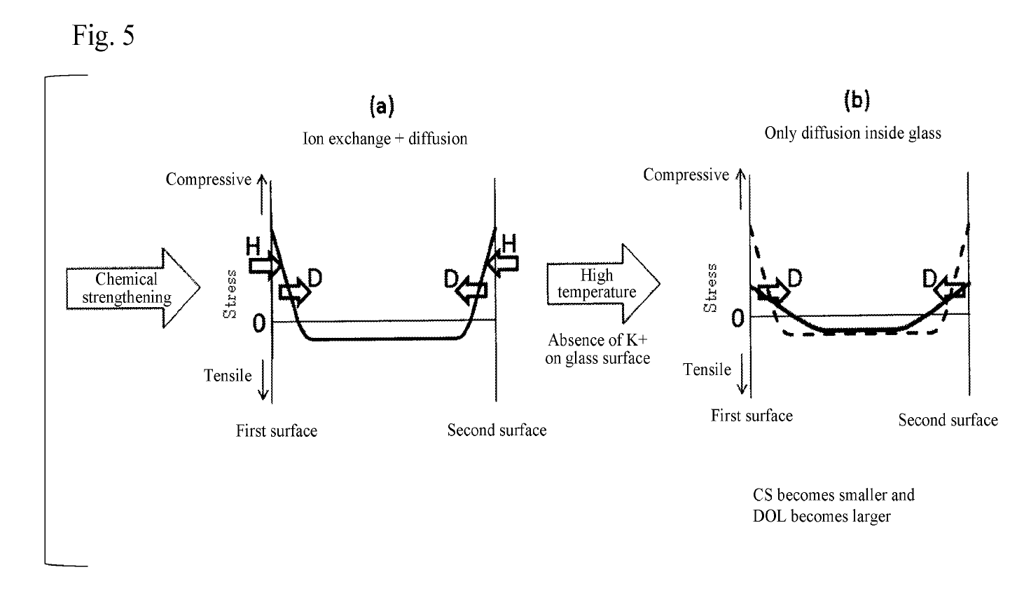

FIG. 5 illustrates a stress profile in a case where a glass sheet is chemically strengthened through immersion in a melt of a metal salt containing K ions (molten salt) and then the glass sheet is taken out of the molten salt and left at a high temperature. As illustrated in FIG. 5, when a glass sheet is first chemically strengthened through immersion in a molten salt, ion diffusion occurs along with ion exchange to provide a stress profile illustrated in (a). Subsequently, when the glass sheet is taken out of the molten salt and left at a high temperature, ion exchange does not occur because of absence of K ion supply from the molten salt to the glass surface, but since the glass is left at a high temperature, ion diffusion inside the glass still goes on. As a result, the surface compressive stress CS decreases and the depth of compressive stress DOL increases, resulting in a change to the stress profile illustrated by the real line in (b).

In this embodiment, by utilizing the above-mentioned phenomenon that CS decreases and DOL increases, a chemically strengthened glass having a stress profile asymmetric in the thickness direction is produced, in which the depth of compressive stress DOL₁ of the first surface is larger than the depth of compressive stress DOL₂ of the second surface and which has a specific stress distribution in the sheet thickness direction as mentioned above.

First, only one surface (the first surface) of a glass substrate is subjected to chemical strengthening treatment. Accordingly, ion exchange and ion diffusion go on only on the side of the first surface. Subsequently, after the chemical strengthening treatment for the first surface is stopped, only the other surface (the second surface) of the glass substrate is subjected to chemical strengthening treatment. Accordingly, ion exchange and ion diffusion go on the side of the second surface. On the other hand, on the side of the first surface, ion exchange does not occur since no ion for chemical strengthening treatment is supplied thereto. As a result, CS decreases and DOL increases. However, also on the side of the first surface, ion diffusion still goes on owing to the influence thereon of heat of chemical strengthening treatment for the second surface. Between the chemical strengthening treatment for the first surface and the chemical strengthening treatment for the second surface, an intermediate heat treatment may be carried out for sufficiently promote ion diffusion on the side of the first surface.

Subsequently, by stopping the chemical strengthening treatment for the second surface, a chemically strengthened glass having a stress profile asymmetric in the thickness direction, in which the depth of compressive stress DOL₁ of the first surface is larger than the depth of compressive stress DOL₂ of the second surface and which has a specific stress distribution in the sheet thickness direction as mentioned above can be obtained.

Here, the method of chemical strengthening treatment for only one surface of a glass substrate includes, for example, a method of applying an inorganic salt onto the surface to be chemically strengthened followed by heat-treating it.

The inorganic salt used in the method plays a role of exchanging the alkali metal ion having a small ionic radius on the glass surface (typically, Li ion or Na ion) for an alkali ion having a larger ionic radius (typically Na ion or K ion for Li ion, and K ion for Na ion) to thereby form a compressive surface layer on the surface of glass.

The composition of the inorganic salt contains, though not specifically limited thereto, for example, a potassium compound. The potassium compound includes, for example, KNO₃, KCl, KBr, KI, KF, and K₂SO₄. Except potassium compounds, for example, salt containing a sodium compound such as NaNO₃ in an amount of about 5% or less is also usable.

An additive such as a solvent, a thickener or the like may be added to the inorganic salt. The solvent includes, for example, a liquid capable of dissolving, dispersing or suspending a potassium compound or a sodium compound, and a substance based with the liquid, and may be one based with water or alcohol. The thickener includes, for example, an organic resin and an organic solvent.

A resin that decomposes at the heat treatment temperature is usable as the organic resin, and the one that can be readily removed by washing with water is preferable. Examples thereof include a cellulose resin, methyl cellulose resin, a cellulose acetate resin, a cellulose nitrate resin, a cellulose acetate butyrate resin, an acrylic resin, and a petroleum resin each having such properties.

As the organic solvent, one that can readily disperse a metal compound and an organic resin and can readily evaporate in drying is preferable, and specifically, an organic solvent that is liquid at room temperature (20° C.) and evaporate at from 50 to 200° C. or so is preferable. Such an organic solvent includes, for example, alcohols such as methanol or ethanol, dimethyl ether and ketones such as acetone.

The amount of the additive to the inorganic salt for use in the present invention is not specifically limited.

It is preferable that the inorganic salt for use in the present invention is, from the viewpoint of easiness in coating, one whose viscosity can be controlled in accordance with each process. The method for viscosity control includes, for example, a method of adding a fluidity controlling agent, such as clay such as kaolin, water or aluminosilicate fibers.

Though the viscosity of the inorganic salt for use in the present invention is adequately controllable, in general, it is preferable that the viscosity thereof at 20° C. is from 200 to 100000 mPa·s. The viscosity of the inorganic salt can be measured, for example, by using a viscometer (PM-2B manufactured by Malcom Co., Ltd.), a viscosity cup (NK-2 manufactured by Anest Iwata Corporation) or the like.

For the method of applying an inorganic salt to the front surface or the rear surface of the glass substrate, any known coater is usable with no specific limitation, and examples thereof include a curtain coater, a bar coater, a roll coater, a die coater, and a spray coater.

The heat treatment temperature may be adequately set depending on the type of the inorganic salt, and is, in general, preferably from 350 to 600° C., more preferably from 400 to 550° C.

The heat treatment time may be adequately set and, in general, it is preferably from 5 minutes to 10 hours, more preferably 30 minutes to 4 hours after reaching a predetermined heat treatment temperature.

For stopping the chemical strengthening treatment, for example, the chemically strengthened glass after heat treatment is washed to remove the inorganic salt from the surface thereof.

In the case where the ion exchange amount on the first surface of a glass substrate differs from the ion exchange amount on the second surface of the glass substrate, there may form an expansion difference between the first surface and the second surface so that warp may occur on the resultant chemically strengthened glass. Consequently, for preventing the development of warp caused by chemical strengthening treatment, it is preferable to make the ion exchange amount on the first surface of a glass substrate equal to the ion exchange amount on the second surface of the glass substrate. For example, using a glass substrate in which the main surfaces of the first surface and the second surface are flat surfaces parallel to each other, the first surface of the glass substrate is chemically strengthened under predetermined conditions (heat treatment temperature, heat treatment time, inorganic salt composition, or the like), and then the second surface thereof is also chemically strengthened under the same conditions, whereby a chemically strengthened glass having an asymmetric stress profile with no warp can be obtained. In that case, the chemical strengthening treatment conditions are preferably selected so that an absolute value of the difference between CS of the first surface immediately after conducting the chemical strengthening treatment to the first surface and CS of the second surface immediately after conducting the chemical strengthening treatment to the second surface (hereinafter this may be referred to as an absolute value of CS difference) would be 20 MPa or less and that an absolute value of the difference between DOL of the first surface immediately after conducting the chemical strengthening treatment to the first surface and DOL of the second surface immediately after conducting the chemical strengthening treatment to the second surface (hereinafter this may be referred to as an absolute value of DOL difference) would be 10 m or less, more preferably 7 m or less, further more preferably 5 m or less, and especially preferably 2 μm or less. Also, the chemical strengthening treatment conditions where the absolute value of CS difference is 10 MPa or less and the absolute value of DOL difference is 1 μm or less is more preferable, and the chemical strengthening treatment conditions where the absolute value of CS difference is 0 MPa and the absolute value of DOL difference is 0 μm is especially preferable. However, in the case where warp caused by chemical strengthening treatment is allowable, the chemical strengthening treatment conditions for the first surface of the glass substrate and the chemical strengthening treatment conditions for the second surface of the glass substrate may be set to be different conditions from each other.

Values of CS and DOL of the first surface immediately after conducting the chemical strengthening treatment to the first surface differ from values of CS and DOL, respectively, of the first surface immediately after conducting the chemical strengthening treatment to the second surface, and the latter are equal to the above-mentioned CS₁ and DOL₁, respectively.

The method for producing a chemically strengthened glass that has a stress profile asymmetric in the thickness direction includes, in addition to the method mentioned above, for example, a method of using a film that blocks ion exchange (hereinafter this may be referred to as an ion-exchange blocking film). In this method, for example, glass is subjected to ion-exchange through immersion in a molten salt in a state where an ion-exchange blocking film is provided on the second surface thereof, and then the glass is pulled up from the molten salt. Subsequently, the ion-exchange blocking film provided on the second surface is removed, and then in a state where an ion-exchange blocking film is provided on the first surface thereof, the glass is subjected to ion-exchange through immersion in a molten salt. In that manner, a chemically strengthened glass that has a stress profile asymmetric in the thickness direction can be produced. The molten salt includes, for example, alkali nitrates, alkali sulfates and alkali chlorides such as potassium nitrate, potassium sulfate and potassium chloride. These molten salts can be used independently or in combination of two or more types thereof. For adjusting the chemical strengthening characteristics, a sodium-containing salt may be mixed in. The ion-exchange treatment conditions are not specifically limited, and most suitable conditions may be selected in consideration of the characteristics of glass, molten salts or the like.

Apart from the method of using an ion-exchange blocking film as mentioned above, for example, a method of applying an inorganic salt to the surface to be chemically strengthened and then applying a voltage thereto for ion injection is also applicable. In this method, ion injection may be carried out separately on one surface after another with varying the conditions of voltage, inorganic salt concentration or the like, whereby a chemically strengthened glass that has a stress profile asymmetric in the thickness direction can be produced. The above-mentioned methods for producing a chemically strengthened glass that has a stress profile asymmetric in the thickness direction (a method of coating with an inorganic salt followed by heat treatment, a method of using an ion-exchange blocking film, or a method of coating with an inorganic salt followed by voltage application) may be applied to the first surface and the second surface separately and to one surface after another.

In one embodiment of the present invention, the radius of curvature of the chemically strengthened glass may be 15000 mm or more. Here, “the radius of curvature is 15000 mm or more” means that under the condition that the first surface of glass is a convex surface and the second surface thereof is a concave surface, or under the condition that the first surface thereof is a concave surface and the second surface thereof is a convex surface, the radius of the slightly observed curvature is 15000 mm or more. The chemically strengthened glass like this can be obtained, for example, by conducting the above-mentioned chemical strengthening treatment (ion exchange treatment) to a tabular glass substrate under the condition that the absolute difference between the ion exchange amount on the first surface and the ion exchange amount on the second surface is small, and the warp caused by the absolute difference in the ion exchange amount is small.

In one embodiment of the present invention, the radius of curvature of the chemically strengthened glass may be less than 15000 mm. Here, “the radius of curvature is less than 15000 mm” means that under the condition that the first surface of glass is a convex surface and the second surface thereof is a concave surface, or under the condition that the first surface thereof is a concave surface and the second surface thereof is a convex surface, the radius of the observed curvature is less than 15000 mm. In the case where the chemically strengthened glass like this is used in applications that are required to have good design appearance, the convex surface side thereof is often an exposed surface and the glass may be more readily cracked as compared with the case where the concave surface is an exposed surface. Consequently, in the case, it is desirable that the first surface is a convex surface and the second surface is a concave surface. The chemically strengthened glass like this can be obtained, for example, by conducting the above-mentioned chemical strengthening treatment (ion exchange treatment) to a tabular glass substrate under the condition that the absolute difference between the ion exchange amount on the first surface and the ion exchange amount on the second surface is large, and the warp of the glass caused by the absolute difference in the ion exchange amount is large.

The chemically strengthened glass of one embodiment of the present invention may be one obtained by processing a curved glass substrate according to the above-mentioned chemical strengthening treatment. As the curved glass substrate, for example, a glass unprocessed for chemical strengthening treatment and having a radius of curvature of less than 15000 mm is usable.

As described above, the chemically strengthened glass of one embodiment of the present invention is one having a stress profile asymmetric in the thickness direction, in which the depth of compressive stress DOL₁ of the first surface is larger than the depth of compressive stress DOL₂ of the second surface, and which has a specific stress distribution in the sheet thickness direction as mentioned above. Consequently, the chemically strengthened glass of one embodiment of the present invention can satisfy different chemical strengthening characteristics that are separately required for the front and rear surfaces of glass, as compared with a chemically strengthened glass that has a stress profile substantially symmetric in the thickness direction (a chemically strengthened glass in which the depth of compressive stress DOL of both surfaces is equivalent to the depth of compressive stress DOL₁ of the first surface of the chemically strengthened glass of one embodiment of the present invention, and the tensile stress distribution in the sheet thickness direction does not satisfy any of the above-mentioned relational expression (1) and the above-mentioned relational expression (2)). Specifically, according to the present invention, excellent fracture resistance can be exhibited when collision objects having a relatively small angle at the collision part such as collision objects having a sharp edge collide against the first surface thereof, high fracture resistance can be provided even after getting flawed on the first surface thereof and explosive glass fracture caused by tensile stress can be more effectively suppressed or prevented, as compared with a chemically strengthened glass that has a stress profile substantially symmetric in the thickness direction.

The chemically strengthened glass of the present invention can be usefully used, for example, for cover glasses of display devices such as mobile devices such as mobile phones or smartphones, televisions, personal computers, or touch panels. Specifically, various collision objects may collide against the surface exposed outside (exposed surface) of cover glasses of display devices to cause a damage of the glass. Here, for example, in the case where collision objects having a relatively large angle at the collision part, such as spherical collision objects or the like collide against the exposed surface of a cover glass, bending is generated in the cover glass, and the surface (rear surface) opposite to the collision surface of the cover glass is given an external force (tensile stress) by bending. Consequently, it is preferable that CS of the rear surface of the cover glass is larger so as to be able to resist to the external force by bending. Also, when collision objects having a relatively small angle at the collision part, such as collision objects having a sharp edge or the like collide against the exposed surface of a cover glass, the exposed surface of the cover glass may be flawed, and in the case where the flaw reaches deeper than the compressive stress layer and where the internal tensile stress is large, the cover glass is cracked. Consequently, for making a cover glass resistant to flaw, it is preferable that DOL on the side of the exposed surface of the cover glass is larger and that the internal tensile stress is smaller.

Here, in the chemically strengthened glass of the present invention, the depth of compressive stress DOL₁ of the first surface is larger than the depth of compressive stress DOL₂ of the second surface, and the glass has the above-mentioned specific stress distribution in the sheet thickness direction, and therefore, for example, when the first surface having a large depth of compressive stress is made to be an exposed surface and the second surface having a large surface compressive stress is made to be a rear surface, the cover glass can satisfy the characteristics desired for use in display devices. In addition, since the internal tensile stress can be made to be smaller, glass fracture can be more effectively suppressed or prevented. Accordingly, it is favorably used as a cover glass for display devices.

In addition, apart from cover glasses for display devices, the chemically strengthened glass of the present invention can also be usefully used in other various applications that require chemical strengthening characteristics differing in every different surfaces. For example, it can be usefully used for building materials such as windowpanes for constructions such as houses or buildings, vehicle members for use for vehicles such as automobiles (for example, windshields, mirrors, windowpanes, or interior members), optical lenses, medical instruments, or dishes.

### EXAMPLES

Hereinunder the present invention is described with reference to Examples, but the present invention is not restricted by these.

### Example 1

A glass whose composition is shown below was formed according to a float method so that it has a sheet thickness of 0.56 mm, and then cut into 50 mm×50 mm to produce a glass substrate. The produced glass had no warp.

Glass composition (mol % expression): SiO₂64.2%, Al₂O₃ 8.0%, Na₂O 12.5%, K₂O 4.0%, MgO 10.5%, CaO 0.1%, SrO 0.1%, BaO 0.1%, ZrO₂ 0.5%

Subsequently, a pasty inorganic salt having the following composition was applied onto one surface (first surface) of the produced glass substrate to give the thickness of 1.5 mm, by using a desktop coater.

Composition of pasty inorganic salt (ratio by mass) Water:K₂SO₄:KNO₃=6:5:1

The glass substrate coated with the pasty inorganic salt only on the first surface thereof was transferred into a heating furnace, and heated therein at 500° C. for 15 minutes to conduct chemical strengthening treatment to the first surface alone of the glass substrate. Subsequently, the glass substrate was cooled down to room temperature, and washed to remove the inorganic salt applied to the first surface.

Subsequently, to the second surface of the glass substrate, chemical strengthening treatment was conducted under the same chemical strengthening treatment condition as chemically treatment condition for the first surface except that the heat treatment temperature was 400° C. and the heat treatment time was 200 minutes. Afterwards, the glass substrate was cooled down to room temperature, and washed to remove the inorganic salt applied to the first surface, thereby a chemically strengthened glass of Example 1 was produced. Two sample sheets of the chemically strengthened glass of Example 1 were prepared, and were individually referred to as Example 1-1 and Example 1-2.

### Example 2

A chemically strengthened glass of Example 2 was produced in the same manner as in Example 1 except that the thickness t of the glass substrate was 0.85 mm. Two sample sheets of the chemically strengthened glass of Example 2 were prepared, and were individually referred to as Example 2-1 and Example 2-2.

### Example 3

A chemically strengthened glass of Example 3 was produced in the same manner as in Example 1 except that the thickness t of the glass substrate was 2.00 mm. Two sample sheets of the chemically strengthened glass of Example 3 were prepared, and were individually referred to as Example 3-1 and Example 3-2.

### Example 4

A glass substrate was prepared in the same manner as in Example 1 except that the thickness t of the glass substrate was 0.85 mm.

Subsequently, 0.8 g of a powder having a composition mentioned below was applied onto one surface (first surface) of the glass substrate in such a manner that the glass surface was covered therewith in a uniform thickness.

Composition of powder (ratio by mass) KNO₃:K₂SO₄:=1:1

The glass substrate applied with the powder on the first surface thereof was transferred into a heating furnace, and fired therein at 420° C. for 540 minutes to conduct chemical strengthening treatment. Subsequently, the glass substrate was cooled down to room temperature, then washed with pure water to remove the powder applied on the first surface, and dried.

The glass substrate was transferred into the heating furnace, and fired therein at 420° C. for 540 minutes to conduct intermediate heat treatment. Subsequently, the glass substrate was cooled down to room temperature.

The glass substrate where the second surface was applied with the powder under the same condition as that for the first surface was transferred into the heating furnace, and fired at 420° C. for 360 minutes to conduct chemical strengthening treatment. Subsequently, the glass substrate was cooled down to room temperature, washed with pure water to remove the powder applied on the first surface, and dried to produce a chemically strengthened glass of Example 4. Two sample sheets of the chemically strengthened glass of Example 4 were prepared, and were individually referred to as Example 4-1 and Example 4-2.

### Example 5

A chemically strengthened glass of Example 5 was produced in the same manner as in Example 4 except that the intermediate heat treatment time was 900 minutes. Two sample sheets of the chemically strengthened glass of Example 5 were prepared, and were individually referred to as Example 5-1 and Example 5-2.

### Comparative Example 1

The same glass substrate as that prepared in Example 1 was chemically strengthened through immersion in a molten salt of KNO₃ at 450° C. for 60 minutes. Subsequently, the glass substrate was cooled down to room temperature, and washed to produce a chemically strengthened glass of Comparative Example 1. Two sample sheets of the chemically strengthened glass of Comparative Example 1 were prepared, and were individually referred to as Comparative Example 1-1 and Comparative Example 1-2.

### Comparative Example 2

A chemically strengthened glass of Comparative Example 2 was produced in the same manner as in Comparative Example 1 except that the immersion time in the molten salt of KNO₃ at 450° C. was changed to 150 minutes. Two sample sheets of the chemically strengthened glass of Comparative Example 2 were prepared, and were individually referred to as Comparative Example 2-1 and Comparative Example 2-2.

### Comparative Example 3

A chemically strengthened glass of Comparative Example 3 was produced in the same manner as in Comparative Example 1 except that the thickness t of the glass substrate was 0.85 mm. Two sample sheets of the chemically strengthened glass of Comparative Example 3 were prepared, and were individually referred to as Comparative Example 3-1 and Comparative Example 3-2.

### Comparative Example 4

A chemically strengthened glass of Comparative Example 4 was produced in the same manner as in Comparative Example 2 except that the thickness t of the glass substrate was 0.85 mm. Two sample sheets of the chemically strengthened glass of Comparative Example 4 were prepared, and were individually referred to as Comparative Example 4-1 and Comparative Example 4-2.

### Comparative Example 5

A chemically strengthened glass of Comparative Example 5 was produced in the same manner as in Comparative Example 1 except that the thickness t of the glass substrate was 2.00 mm. Two sample sheets of the chemically strengthened glass of Comparative Example 5 were prepared, and were individually referred to as Comparative Example 5-1 and Comparative Example 5-2.

### Comparative Example 6

A chemically strengthened glass of Comparative Example 6 was produced in the same manner as in Comparative Example 2 except that the thickness t of the glass substrate was 2.00 mm. Two sample sheets of the chemically strengthened glass of Comparative Example 6 were prepared, and were individually referred to as Comparative Example 6-1 and Comparative Example 6-2.

<Depth of Compressive Stress DOL₁ and DOL₂>

The depth of compressive stress DOL₁ (μm) of the first surface and the depth of compressive stress DOL₂ (μm) of the second surface of each chemically strengthened glass were measured by using a surface stress meter manufactured by Orihara Manufacturing (FSM-6000LE). The results are shown in Table 1. The surface having a larger depth of compressive stress is regarded as the first surface.

<Surface Compressive Stress CS₁ and CS₂>

The surface compressive stress CS₁ (MPa) of the first surface and the surface compressive stress CS₂ (MPa) of the second surface of each chemically strengthened glass were measured by using a surface stress meter manufactured by Orihara Manufacturing (FSM-6000LE). The results are shown in Table 1.

### <Stress Distribution in Sheet Thickness Direction>

The stress distribution in the sheet thickness direction of each chemically strengthened glass was determined according to a process of the following (1) to (6).

(1) First, a measurement sample was cut out of each chemically strengthened glass. Specifically, from each chemically strengthened glass having a size of the first surface and the second surface of 50 mm×50 mm and a thickness t of 0.5 mm, 0.85 mm or 2.00 mm, a small piece having a size of the first surface and the second surface of 20 mm×1 mm and having the thickness t of 0.5 mm, 0.85 mm or 2.00 mm without changing was cut out, and then the facing two surfaces having a dimension of 20 mm×(thickness t) were mirror-polished from both sides to prepare a measurement sample having a width of 0.3 mm and a surface roughness Ra of the two surfaces (measurement surfaces) of 5 nm or less.

(2) Next, in the measurement sample, by using a birefringence imaging system Abrio (manufactured by Tokyo Instruments), the refractive index distribution and the Azi distribution in the thickness direction of the measurement samples were measured. In measuring the refractive index distribution, the magnification of the objective lens of the systematic biological microscope BX51TF (manufactured by Olympus) was regulated to be from 4 to 20 powers so as to enable measurement of the entire measurement surface of the measurement sample. Regarding the measurement condition for the refractive index distribution, the retardation range was 34 nm.

(3) Next, the refractive index constituting each plot of the resultant refractive index distribution was multiplied by a photoelastic constant kc to obtain a stress distribution. Regarding the photoelastic constant kc, kc=28.3.

(4) In the Azi distribution, the point in the thickness direction at which the value changes from inside the range of 180n−10≦Azi≦180n+10 (n=0, 1) to outside thereof was referred to as a changing point, and the coordinates of the two changing points A and B were analyzed.

(5) Where the distribution showed a minimum value at the point in the thickness direction nearest to the each coordinates of the changing points A and B determined in (4), the points in the thickness direction at the minimum value were referred to as x_{A} and x_{B}, respectively. Between x_{A} and x_{B}, the point nearer to the first surface was referred to as x₀, and the point remoter from the first surface was as x_{L}.

(6) Finally, through plus-minus inversion in the distribution outside the range of from x_{A} to x_{B} (from x₀ to x_{L}), a stress distribution was obtained in which tensile stress was positive and compressive stress was negative.

From the resultant stress distribution, the following CT₁, CT₂, x₀, x_{L}, x₁, x₂, and L were measured or calculated.

CT₁: A maximum value of tensile stress (MPa) in a region of the depth from the first surface, X=from x₀ to x₁

CT₂: A maximum value of tensile stress (MPa) in a region of the depth from the first surface, X=from x₂ to x_{L}

x₀: A depth from the first surface (mm) to the point at which compressive stress turns first into tensile stress in the stress distribution in the sheet thickness direction from the first surface to the second surface

x₁: A depth from the first surface (mm) to the point at which compressive stress turns first into tensile stress in the stress distribution in the sheet thickness direction from the second surface to the first surface

x₁=0.8x₀+0.2x_{L}(mm)

x₂=0.2x₀+0.8x_{L}(mm)

L=x_{L}−x₀ (mm)

In addition, from the measured CT₁, CT₂ and L, CT₁/CT₂, CT₁×L^{1/2} and CT₂×L^{1/2} were calculated.

In addition, CT(X) (MPa) in a region of the depth X (mm) from the first surface of from x₁ to x₂ (mm)(x₁≦X≦x₂) was standardized in a linear line, represented by CTₙ(X)=a(X/L²)+b, by using the thickness of the tensile stress layer L=x_{L}−x₀ (mm) to thereby calculate a.

L, CT₁, CT₂, CT₁/CT₂, CT×L^{1/2}, CT₂×_{L}^{1/2}, and a in each Examples and Comparative Examples are shown in Table 1.

### <Fracture Rate Test>

By using a Vickers hardness meter (Future-Tech's FLS-ARS9000) with regard to each chemically strengthened glass, a Vickers indenter (shape: four-sided pyramid, tip angle: 110°) was indented into the first surface of the chemically strengthened glass at a rate of 60 μm/sec until any of the following load could be given thereto and kept for 15 seconds. Then the load was removed by removing the Vickers indenter, whereupon the area around the impression was observed to confirm the presence or absence of fracture. The measurement was carried out at every load of 1 kgf, 1.5 kgf, 2 kgf, 2.5 kgf, 3 kgf, 3.5 kgf, 4 kgf, 5 kgf, 6 kgf, and 7 kgf for 10 sheets of the glass. 1 kgf=9.8 N. With that, the load K (kgf) which shows 50% fracture in average was calculated to be the Vickers injury fracture load. The results are shown in Table 1.

TABLE 1

| | | | | | | | | | | | | | | Fracture |
|---|---|---|---|---|---|---|---|---|---|---|---|---|---|---|
| | | t | CS₁ | CS₂ | DOL₁ | DOL₂ | L | CT₁ | CT₂ | CT₁/CT₂ | CT₁ × L^{1/2} | CT₂ × L^{1/2} | | Load K |
| | | [mm] | [MPa] | [MPa] | [μm] | [μm] | [mm] | [MPa] | [MPa] | [—] | [MPa · | [MPa · mm^{1/2}] | a | [kgf] |
| Ex. 1 | Ex. 1-1 | 0.56 | 374.8 | 743.3 | 50.4 | 29.9 | 0.486 | 24.94 | 48.54 | 0.51 | 17.4 | 33.85 | 8.8 | 2.4 |
| | Ex. 1-2 | | | | | | 0.486 | 22.57 | 48.01 | 0.47 | 15.7 | 33.49 | 9.6 | |
| Com. | Com. Ex. | | 820.5 | 810.0 | 31.6 | 31.3 | 0.520 | 42.00 | 43.62 | 0.96 | 30.3 | 31.44 | 1.2 | 2.1 |
| Ex. 1 | 1-1 | | | | | | | | | | | | | |
| | Com. Ex. | | | | | | 0.508 | 41.55 | 43.44 | 0.96 | 29.6 | 30.97 | 0.9 | |
| | 1-2 | | | | | | | | | | | | | |
| Com. | Com. Ex. | | 759.7 | 750.2 | 47.2 | 47.2 | 0.485 | 56.61 | 57.11 | 0.99 | 39.4 | 39.79 | −1.0 | 1.7 |
| Ex. 2 | 2-1 | | | | | | | | | | | | | |
| | Com. Ex. | | | | | | 0.485 | 56.02 | 56.61 | 0.99 | 39.0 | 39.43 | 0.4 | |
| | 2-2 | | | | | | | | | | | | | |
| Ex. 2 | Ex. 2-1 | 0.85 | 359.3 | 764.6 | 47.3 | 31.6 | 0.762 | 19.38 | 41.04 | 0.47 | 16.9 | 35.83 | 7.4 | 6.0 |
| | Ex. 2-2 | | | | | | 0.763 | 19.36 | 33.72 | 0.57 | 16.9 | 29.45 | 6.9 | |
| Ex. 4 | Ex. 4-1 | | 219.0 | 535.2 | 85.5 | 46.6 | 0.676 | 28.16 | 30.93 | 0.91 | 23.1 | 25.43 | 6.8 | 8.3 |
| | Ex. 4-2 | | | | | | 0.675 | 27.69 | 31.21 | 0.89 | 22.8 | 25.65 | 7.7 | |
| Ex. 5 | Ex. 5-1 | | 182.9 | 530.8 | 87.6 | 47.7 | 0.669 | 29.51 | 29.28 | 1.01 | 24.1 | 23.95 | 5.8 | 8.4 |
| | Ex. 5-2 | | | | | | 0.670 | 30.40 | 30.21 | 1.01 | 24.9 | 24.72 | 5.5 | |
| Com. | Com. Ex. | | 748.6 | 752.2 | 30.8 | 30.3 | 0.778 | 34.94 | 38.14 | 0.92 | 30.8 | 33.64 | 1.6 | 3.1 |
| Ex. 3 | 3-1 | | | | | | | | | | | | | |
| | Com. Ex. | | | | | | 0.777 | 34.19 | 38.14 | 0.90 | 30.1 | 33.62 | 1.6 | |
| | 3-2 | | | | | | | | | | | | | |
| Com. | Com. Ex. | | 758.6 | 750.3 | 47.7 | 45.4 | 0.755 | 39.83 | 41.90 | 0.95 | 34.6 | 36.40 | 1.7 | 2.4 |
| Ex. 4 | 4-1 | | | | | | | | | | | | | |
| | Com. Ex. | | | | | | 0.754 | 39.20 | 41.45 | 0.95 | 34.0 | 36.00 | 1.5 | |
| | 4-2 | | | | | | | | | | | | | |
| Ex. 3 | Ex. 3-1 | 2.00 | 461.2 | 762.6 | 43.1 | 29.9 | 1.899 | 11.39 | 19.15 | 0.60 | 15.7 | 26.39 | 8.5 | 25.0 |
| | Ex. 3-2 | | | | | | 1.899 | 11.45 | 19.99 | 0.57 | 15.8 | 27.55 | 8.7 | |
| Com. | Com. Ex. | | 799.4 | 799.9 | 32.6 | 31.8 | 1.898 | 21.89 | 23.01 | 0.95 | 30.2 | 31.70 | 1.0 | 19.0 |
| Ex. 5 | 5-1 | | | | | | | | | | | | | |
| | Com. Ex. | | | | | | 1.898 | 21.98 | 24.22 | 0.91 | 30.3 | 33.36 | 1.3 | |
| | 5-2 | | | | | | | | | | | | | |
| Com. | Com. Ex. | | 800.5 | 799.0 | 45.4 | 44.4 | 1.881 | 23.01 | 24.03 | 0.96 | 31.6 | 32.95 | 2.0 | 15.0 |
| Ex. 6 | 6-1 | | | | | | | | | | | | | |
| | Com. Ex. | | | | | | 1.880 | 23.61 | 24.09 | 0.98 | 32.4 | 33.03 | 2.0 | |
| | 6-2 | | | | | | | | | | | | | |

From the results in Table 1, it is known that the glass of Examples 1 to 3 where CT₁/CT₂ is 0.8 or less has a large fracture load K and can exhibit excellent fracture resistance when collision objects having a relatively small angle at the collision part such as collision objects having a sharp edge collide against the first surface.

In addition, from the results in Table 1, it is also known that the glass of Examples 1 to 3 and Examples 4 to 5 where the inclination a of CTₙ(X) is 3 or more has a large fracture load K and can exhibit excellent fracture resistance when collision objects having a relatively small angle at the collision part such as collision objects having a sharp edge collide against the first surface. When the inclination a of CTₙ(X) is 3 or more, the tensile stress distribution in the sheet thickness direction inside the glass is inclined, and therefore the tensile stress in the glass surface is relatively low so that even when the glass surface is given deep flaws, it is hardly cracked.

### <Sand Paper Falling Ball Test>

For the each chemically strengthened glasses of Example 2-1, Example 4-1, Example 5-1, Comparative Example 3-1, and Comparative Example 4-1, shock test was conducted to compare injury strength, in which the chemically strengthened glass was arranged on a base, and while the rubbing surface of a sand paper containing an abrasive having a size larger than the depth of the compressive stress layer was kept in contact with the first surface of the chemically strengthened glass, a collision object was dropped down from the above. An antiscattering film was stuck to the second surface of the chemically strengthened glass, which is not in contact with the rubbing surface of the sand paper. An iron plate was arranged in the center of a stand below an autograph, and a rubber sheet having a thickness of 1 mm was arranged thereon to be a base. The chemically strengthened glass was arranged so that the antiscattering film-stuck second surface thereof would be in contact with the base and that the rubbing surface of a sand paper of 25 mm×25 mm (grain size #30, JIS R 6251 standardized product) would be in contact with the center of the first surface of the chemically strengthened glass. A stainless ball having a mass of 64 g and a diameter of 25 mm was dropped down from a height of 20 mm at a step of 10 mm, from the center axis above the autograph, whereupon the height at which a crack was generated was recorded to refer to an average value of five-time falling test data as a sand paper falling ball mean fracture height (mm). The results are shown in Table 2.

TABLE 2

| | | Sand Paper Falling Ball |
|---|---|---|
| | CT₂ × L^{1/2} | Mean Fracture Height |
| | [MPa · mm^{1/2}] | [mm] |
| Ex. 2-1 | 16.9 | 258 |
| Ex. 4-1 | 23.1 | 338 |
| Ex. 5-1 | 24.1 | 278 |
| Com. Ex. 3-1 | 30.8 | 206 |
| Com. Ex. 4-1 | 34.6 | 66 |

From the results in Table 2, it is known that the glass of Example 2-1, Example 4-1 and Example 5-1 in which CT₁×L^{1/2} is 30 or less (MPa·mm^{1/2}) has a high sand paper falling ball mean fracture height and can more effectively suppress or prevent explosive glass fracture caused by tensile stress.

The present invention is described in detail with reference to specific embodiments, but it is apparent for those skilled in the art that various changes or modifications can be added without departing from the spirit and the scope of the present invention.

This application is based upon Japanese Patent Application (Application No. 2015-120621), filed on Jun. 15, 2015, the whole of which are incorporated herein by reference.

1. A chemically strengthened glass having a first surface and a second surface facing the first surface, and having a compressive stress layer provided on the first surface and the second surface, wherein:
a depth of compressive stress DOL₁ (μm) of the first surface is larger than a depth of compressive stress DOL₂ (μm) of the second surface, and
a stress distribution in a sheet thickness direction of the chemically strengthened glass satisfies the following relational expression (1) and the following relational expression (3):
CT₁/CT₂≦0.8 (1) and
CT₁×L^{1/2}≦30(MPa·mm^{1/2}) (3),
wherein:
CT₁: a maximum value of a tensile stress (MPa) in a region where a depth from the first surface X is from x₀ to x₁,
CT₂: a maximum value of a tensile stress (MPa) in a region where a depth from the first surface X is from x₂ to x_{L},
x₀: a depth (mm) from the first surface to a point at which a compressive stress turns first into a tensile stress in the stress distribution in the sheet thickness direction from the first surface to the second surface,
x_{L}: a depth (mm) from the first surface to a point at which a compressive stress turns first into a tensile stress in the stress distribution in the sheet thickness direction from the second surface to the first surface,
x₁=0.8x₀+0.2x_{L}(mm),
x₂=0.2x₀+0.8x_{L}(mm), and
L=x_{L}−x₀ (mm).

2. The chemically strengthened glass according to claim 1, wherein:
the depth of compressive stress DOL₁ (μm) of the first surface and the depth of compressive stress DOL₂ (μm) of the second surface satisfy the following relational expression:
DOL₁≧DOL₂+3(μm).

3. A chemically strengthened glass having a first surface and a second surface facing the first surface, and having a compressive stress layer provided on the first surface and the second surface, wherein:
a depth of compressive stress DOL₁ (μm) of the first surface is larger than a depth of compressive stress DOL₂ (μm) of the second surface,
in a stress distribution in a sheet thickness direction of the chemically strengthened glass, a tensile stress function CTₙ(X) (MPa) standardized in a depth X (mm) from the first surface satisfies the following relational expression (2) in a region of X=from x₁ to x₂ (mm), and
the stress distribution in the sheet thickness direction of the chemically strengthened glass satisfies the following relational expression (3):
CTₙ(X)=a(X/L²)+b, wherein a≧3 (2) and
CT₁×L^{1/2}≦30(MPa·mm^{1/2}) (3),
wherein:
CT₁: a maximum value of a tensile stress (MPa) in a region where a depth from the first surface X is from x₀ to x₁,
x₀: a depth (mm) from the first surface to a point at which a compressive stress turns first into a tensile stress in the stress distribution in the sheet thickness direction from the first surface to the second surface,
x_{L}: a depth (mm) from the first surface to a point at which a compressive stress turns first into a tensile stress in the stress distribution in the sheet thickness direction from the second surface to the first surface,
x₁=0.8x₀+0.2x_{L}(mm),
x₂=0.2x₀+0.8x_{L}(mm), and
L=x_{L}−x₀ (mm).

4. The chemically strengthened glass according to claim 3, wherein:
the depth of compressive stress DOL₁ (μm) of the first surface and the depth of compressive stress DOL₂ (μm) of the second surface satisfy the following relational expression:
DOL₁≧DOL₂+3(μm).

5. The chemically strengthened glass according to claim 1, wherein:
the chemically strengthened glass has a radius of curvature of 15000 mm or more.

6. The chemically strengthened glass according to claim 1, wherein:
the chemically strengthened glass has a radius of curvature of less than 15000 mm.

7. The chemically strengthened glass according to claim 1, which is a chemically strengthened curved glass substrate.

8. The chemically strengthened glass according to claim 3, wherein:
the chemically strengthened glass has a radius of curvature of 15000 mm or more.

9. The chemically strengthened glass according to claim 3, wherein:
the chemically strengthened glass has a radius of curvature of less than 15000 mm.

10. The chemically strengthened glass according to claim 3, which is a chemically strengthened curved glass substrate.
